(19) United States
(12) Patent Application Publication
(10) Pub. No.: US 2025/0383146 A1
(43) Pub. Date: Dec. 18, 2025

(54) Storage Box With Heating Function

(71) Applicant: Lian Hu, Wuhan (CN)

(72) Inventor: Lian Hu, Wuhan (CN)

(21) Appl. No.: 18/756,272

(22) Filed: Jun. 27, 2024

(30) Foreign Application Priority Data
Jun. 13, 2024 (CN) 202421339755X

(51) Int. Cl. F26B 9/00; F26B 9/06; F26B 21/10; F26B 23/04

(52) U.S. Cl. CPC F26B 9/003; F26B 9/06; F26B 21/10; F26B 23/04

(57) ABSTRACT

The present invention relates to a storage box with a heating function in the field of cosmetics technology. It consists of a cover and a main body. The cover comprises a pressure plate, a silicone film, and a shell. The silicone film is squeezed and installed on the top of the shell through the plate. There are several round holes on the pressure plate, and a number of notches in the silicone film. This storage box with heating function allows makeup brushes to be inserted into corresponding circular holes of suitable diameters. The cross-shaped notches secure the brush heads, suspending them inside the cover. By activating the switch button and using the display screen and rotation buttons to select the drying time, the drying program starts automatically. It conveniently dries makeup brushes and cotton balls, eliminating the need to wait for air drying.

### TECHNICAL FIELD

The present invention relates to the field of cosmetics technology and specifically is a storage box with heating function.

### BACKGROUND OF THE INVENTION

A storage box is a container used to collect and organize items (often referring to small items such as office supplies, cosmetics, documents, small tools, socks, underwear, etc.), as the name suggests, it is called a storage box.

With the improvement of people's living standards and increasing income, various cosmetics have emerged in the market. Especially for beauty-conscious women, various cosmetics and makeup tools have gradually found their place on their own dressing tables. During the daily makeup process, various makeup brushes, cotton pads, and other products are indispensable. However, the cleaning and storage of these makeup tools often cause headaches for many makeup users. In the process of organizing cosmetics, for example, after using makeup brushes, they need to be cleaned, dried, and then stored. Otherwise, they can easily become moldy and breed bacteria, causing inconvenience in use. Therefore, a storage box with heating function is proposed to solve the above-mentioned problems.

### SUMMARY OF INVENTION

To address the deficiencies in the existing technology, the present invention provides a storage box with heating function, which has the advantages of convenient heating and storage, solving the problem of needing to air dry before storing items in the storage box after cleaning.

To achieve the above objectives, the present invention provides the following technical solution: A storage box with heating function, comprising a storage box. The storage box is composed of a cover and a main body;

The cover comprises a pressure plate, a silicone film, and a shell. The silicone film is squeezed and installed on the top of the shell through the plate. There are several round holes on the pressure plate, and a number of notches in the silicone film. The upper part of the shell also has a plurality of holes that correspond in number, size, and vertical position to the circular holes. The circular holes, notches, and holes are coaxially aligned in the upper, middle and lower part;

The main body comprises an upper shell, a lower shell, a fan, a heating module, and a control panel. The middle part of the upper shell has an air outlet, and the upper shell has drainage holes located on both sides of the air outlet. The lower shell is equipped with a power button, a display screen, a rotation button, a power interface, and a drainage port. The control panel is installed on the lower shell;

The heating module consists of a protective shell, a protective shell cover, a heating unit, and a temperature controller. The protective shell has an air outlet and a drainage groove. The heating unit is installed inside the protective shell, and the temperature controller is attached to and installed inside the protective shell along with the heating unit. The protective shell cover has an air inlet, which tightly connects to the air outlet of the fan;

The cover further includes an isolation net, which is horizontally installed within the main body.

Furthermore, the cover is bowl-shaped and inverted onto the main body, and the circular holes have varying diameters, while the notches are in a cross shape.

Furthermore, the number, size, and vertical position of the notches on the pressure plate correspond to the circular holes, allowing makeup brushes to pass through the circular holes, notches, and holes in sequence and enter the interior of the cover, where they are secured by the cross-shaped notches formed in the silicone film.

Furthermore, the fan is a centrifugal fan, the upper shell is groove-shaped, and the air outlet is centrally symmetrically designed for bidirectional air outflow.

Furthermore, the protective shell cover is connected and fixed to the protective shell via buckles, forming a chamber. The fan directs air into the protective shell, and the airflow passes over the heating unit before being discharged through the air outlet, creating a flow channel.

Furthermore, the fan further includes a fan bracket, which secures the fan and the heating module that works in conjunction with the fan, to the bottom of the upper shell.

Compared to the existing technology, the technical solution presented in this application offers the following advantageous effects:

This storage box with heating function allows makeup brushes to be inserted into corresponding circular holes of suitable diameters. The cross-shaped notches on the silicone film secure the brush heads, suspending them within the internal space of the cover. By activating the switch button and using the display screen and rotation buttons to select the desired drying time, the drying program will be initiated. This enables the automatic drying of makeup brushes inside the cover. Thus, it facilitates the convenient handling of makeup products and storage boxes by automatically drying items such as cleaned makeup brushes and cotton balls, eliminating the need to wait for air drying.

### BRIEF DESCRIPTION OF THE DRAWINGS

FIG. 1 illustrates the overall structural three-dimensional diagram of the present invention;

FIG. 2 illustrates the overall structural exploded three-dimensional diagram of the present invention;

FIG. 3 illustrates the structural exploded three-dimensional diagram of the main body of the present invention;

FIG. 4 illustrates the structural exploded three-dimensional diagram of the heating module of the present invention;

FIG. 5 illustrates the top view three-dimensional diagram of the lower shell structure of the present invention.

In the figures: 100 denotes the storage box; 20 denotes the isolation net; 10 denotes to the cover; 11 denotes the pressure plate; 111 denotes the circular holes; 13 denotes the silicone film; 131 denotes the notches; 15 denotes the shell; 151 denotes the holes; 30 denotes the main body; 31 denotes the upper shell; 313 denotes the air outlet; 315 denotes the drainage holes; 32 denotes the lower shell; 321 denotes the switch button; 323 denotes the display screen; 325 denotes the rotation button; 326 denotes the power interface; 33 denotes the fan; 331 denotes the fan bracket; 34 denotes the heating module; 341 denotes the protective shell; 3411 denotes the air outlet; 3413 denotes the drainage groove; 342 denotes the protective shell cover; 344 denotes the heating unit; 346 denotes the temperature controller; 35 denotes the control panel.

### DETAILED DESCRIPTION OF THE EMBODIMENT'S

The following description provides a clear and comprehensive depiction of the technical solution in the embodiments of the present invention, in conjunction with the accompanying drawings in the embodiments of the present invention. It should be noted that the described embodiments are only a part of the embodiments of the present invention, rather than the entire embodiments. Based on the embodiments in the present invention, all other embodiments obtained by ordinary technical personnel in this field without making creative effort, fall within the scope of protection of the present invention.

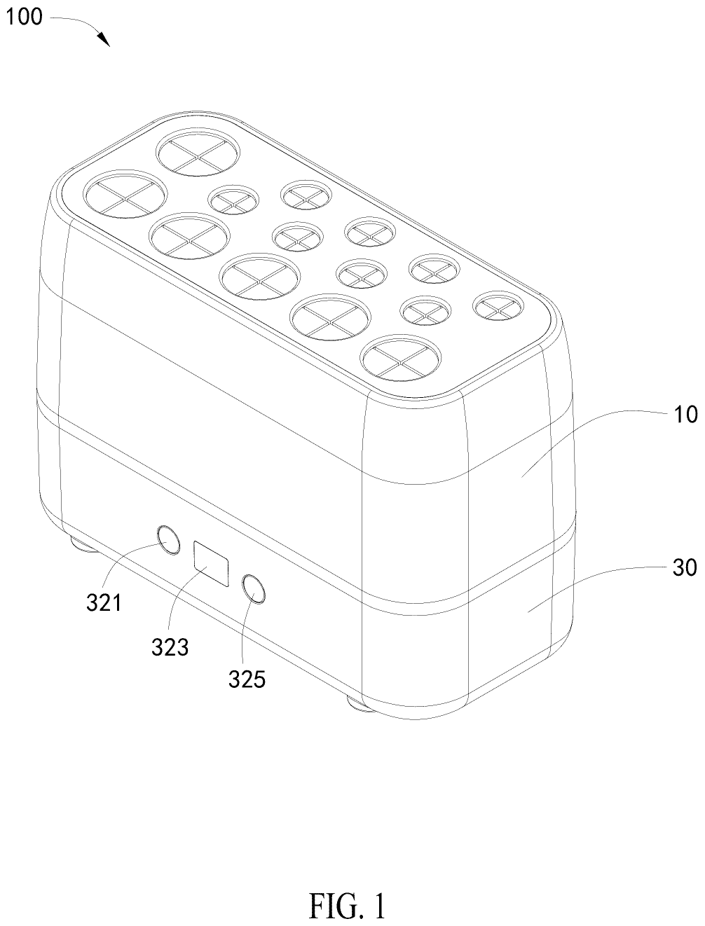

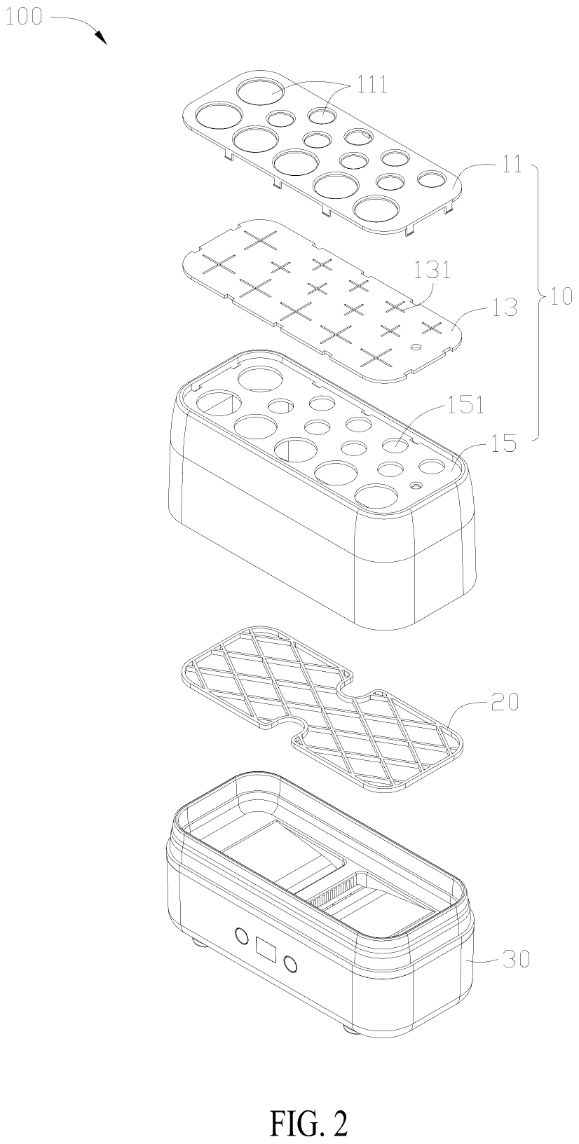

Please refer to FIGS. 1 to 2. In one embodiment of the present invention, a storage box with heating function includes a storage box (100), comprising a cover (10) and a main body (30);

The cover (10) comprises a pressure plate (11), a silicone film (13), and a shell (15). The silicone film is squeezed and installed on the top of the shell through the plate. There are several round holes on the pressure plate, and a number of notches in the silicone film. The upper part of the shell (15) also has a plurality of holes (151) that correspond in number, size, and vertical position to the circular holes (111). The circular holes (111), notches (131), and holes (151) are coaxially aligned in the upper, middle and lower part;

The cover (10) further includes an isolation net (20), which is horizontally installed within the main body (30) to separate and isolate cotton pads from the main body (30). It controls the moisture content inside the cotton pads after cleaning, facilitating quick drying. The drained moisture is expelled through the drainage holes (315) in the upper shell (31), the drainage groove (3413) of the heating module (34), and the drainage outlet of the lower shell (32).

The cover (10) is bowl-shaped and inverted onto the main body (30), forming a cavity for storing items. The circular holes (111) have varying diameters, while the notches (131) are in a cross shape.

Furthermore, the number, size, and vertical position of the notches (131) on the pressure plate (11) correspond to the circular holes (111), allowing makeup brushes to pass through the circular holes (111), notches (131), and holes (151) in sequence and enter the interior of the cover (10), where they are secured by the cross-shaped notches (131) formed in the silicone film (13), suspending the brushes on the cover (10).

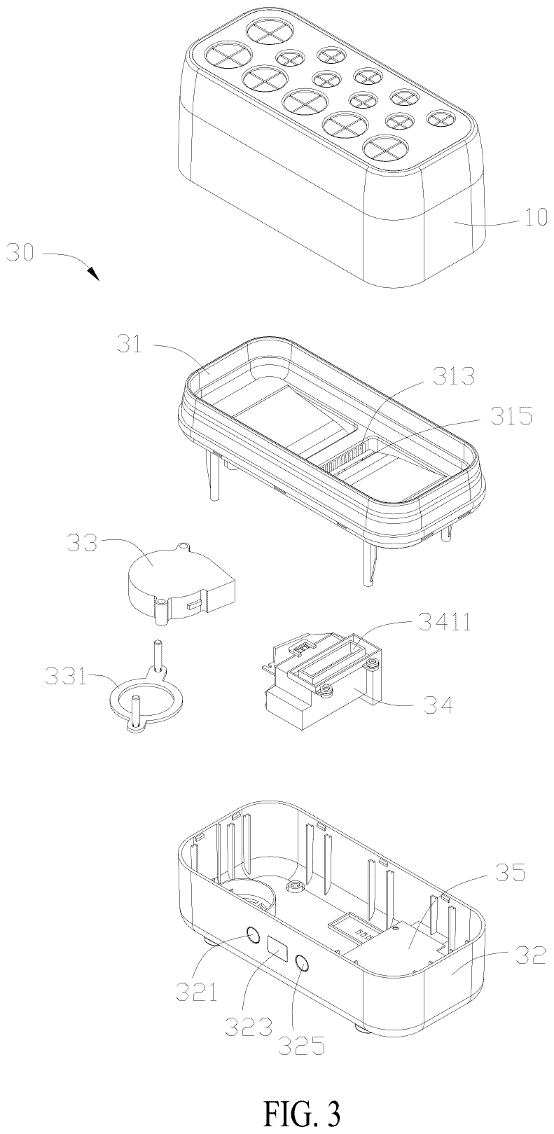

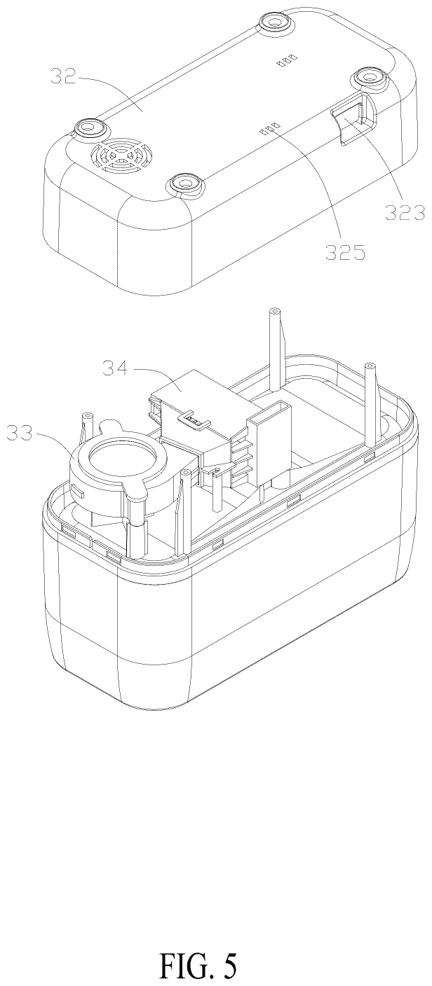

Please refer to FIG. 3 or 5. In this embodiment, the main body (30) comprises an upper shell (31), a lower shell (32), a fan (33), a heating module (34), and a control panel (35). The fan (33) is a centrifugal fan, and the middle part of the upper shell (31) has an air outlet (313). The upper shell (31) is groove-shaped, and the upper shell (31) has drainage holes (315) located on both sides of the air outlet (313). The drainage holes (315), which help remove accumulated water, are located on both sides of the bottom of the upper shell's groove (31). The air outlet (313) is centrally symmetrically designed for bidirectional air outflow. The lower shell (32) is equipped with a power button (321), a display screen (323), a rotation button (325), a power interface (326), and a drainage port (325). The control panel (35) is installed on the lower shell (32).

In this embodiment, the control panel (35) controls the operation of the heating unit (344), temperature controller (346), and fan (33) through electrical connections. The temperature controller (346) continuously monitors the temperature of the heating unit (344). When the set temperature is exceeded, the power supply to the heating unit (344) will be cut off, and the exhaust temperature of the air outlet (3411) of the upper shell (31) will be controlled to achieve drying and protection.

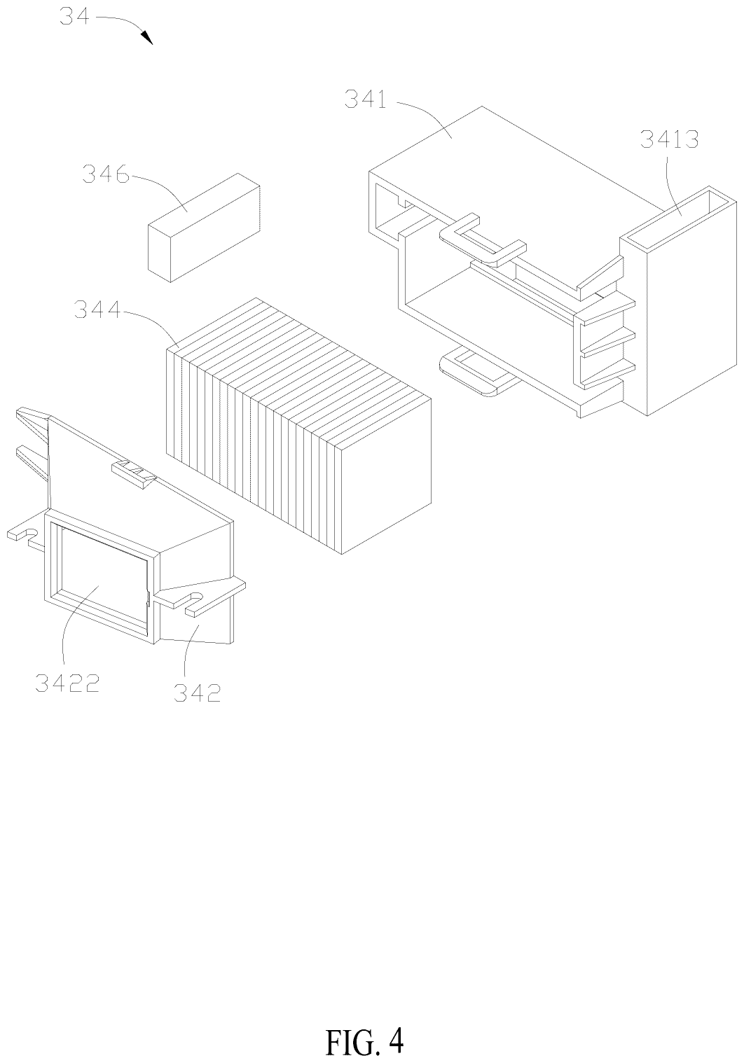

Please refer to FIG. 4. In this embodiment, the heating module (34) consists of a protective shell (341), a protective shell cover (342), a heating unit (344), and a temperature controller (346). The protective shell (341) has an air outlet (3411) and a drainage groove (3413). The heating unit (344) is installed inside the protective shell (341), and the temperature controller (346) is attached to and installed inside the protective shell (341) along with the heating unit (344). The protective shell cover (342) has an air inlet, which tightly connects to the air outlet of the fan (33).

The protective shell cover (342) is connected and fixed to the protective shell (341) via buckles, forming a chamber. The fan (33) directs air into the protective shell (341), and the airflow passes over the heating unit (344) before being discharged through the air outlet (3411), creating a flow channel.

Furthermore, the fan (33) further includes a fan bracket (331), which secures the fan (33) and the heating module (34) that works in conjunction with the fan, to the bottom of the upper shell (31).

It should be noted that the fan bracket (331) is quickly installed by being pressed through the mounting hole of the fan (33). The bottom air outlet (313) of the upper shell (31) is tightly connected to the air outlet (3411) of the heating module (34), allowing the airflow generated by the fan (33) to pass through the heating module (34) and be expelled through the air outlet (313). The upper shell (31) and lower shell (32) are securely installed and fixed with buckles for ease of production and installation;

The entire system adopts an external power supply solution, where the power supply is connected to the device through a power adapter cable inserted into the power interface (326) to provide power. Alternatively, an internal power supply solution can also be used, although detailed principles will not be elaborated upon.

The operational principle of the above embodiment is as follows:

During normal use, the makeup brush is inserted into the corresponding circular hole (111) of appropriate diameter and is securely held in place within the interior space of the cover (10) by the cross-shaped notch (131) on the silicone film (13). By turning on the switch button (321) and using the display screen (323) and rotation button (325), the user can choose the desired drying time and initiate the drying program, which will dry the makeup brush inside the cover (10). The heating unit (344) should stop heating three minutes before the end of the drying process, while the fan (33) continues to operate, dissipating the internal heat of the device to protect it and prevent burns. When using the makeup cotton balls, they will be isolated from the main body (30) by the isolation net (20), which controls the moisture content inside the cotton balls after cleaning, facilitating quick drying. The drained moisture will be expelled from the device through the drainage holes (315) of the upper shell (31), the drainage groove (3413) of the heating module (34), and the drainage outlet of the lower shell (32).

It should be noted that in this document, relational terms such as “first” and “second” are used solely to distinguish one entity or operation from another, without necessarily implying any actual relationship or order between these entities or operations. Furthermore, terms such as “comprise,” “include,” or any variations thereof are intended to encompass non-exclusive inclusion, such that a process, method, article, or device comprising a series of elements includes not only those elements explicitly listed but also other elements not explicitly listed or inherent to such process, method, article, or device. Unless specifically limited, the term “comprising a . . . ” and its variations do not exclude the presence of additional identical elements in a process, method, article, or device comprising the disclosed elements.

Although embodiments of the present invention have been shown and described, for ordinary technical personnel in this field, it can be understood that various changes, modifications, substitutions, and alterations can be made to these embodiments without departing from the principles and spirit of the present invention. The scope of the present invention is defined by the appended claims and their equivalents.

1. A storage box with heating function, comprising a storage box (100), the storage box (100) is characterized by consisting a cover (10) and a main body (30);
The cover (10) comprises a pressure plate (11), a silicone film (13), and a shell (15); the silicone film is squeezed and installed on the top of the shell through the plate; there are several round holes on the pressure plate, and a number of notches in the silicone film; the upper part of the shell (15) also has a plurality of holes (151) that correspond in number, size, and vertical position to the circular holes (111); the circular holes (111), notches (131), and holes (151) are coaxially aligned in the upper, middle and lower part;
The main body (30) comprises an upper shell (31), a lower shell (32), a fan (33), a heating module (34), and a control panel (35); the middle part of the upper shell (31) has an air outlet (313), and the upper shell (31) has drainage holes (315) located on both sides of the air outlet (313); the lower shell (32) is equipped with a power button (321), a display screen (323), a rotation button (325), a power interface (326), and a drainage port (325); the control panel (35) is installed on the lower shell (32);
The heating module (34) consists of a protective shell (341), a protective shell cover (342), a heating unit (344), and a temperature controller (346); the protective shell (341) has an air outlet (3411) and a drainage groove (3413); the heating unit (344) is installed inside the protective shell (341), and the temperature controller (346) is attached to and installed inside the protective shell (341) along with the heating unit (344); the protective shell cover (342) has an air inlet, which tightly connects to the air outlet of the fan (33);
The cover (10) further includes an isolation net (20), which is horizontally installed within the main body (30).

2. The storage box with heating function according to claim 1, characterized in that the cover (10) is bowl-shaped and inverted onto the main body (30), and the circular holes (111) have varying diameters, while the notches (131) are in a cross shape.

3. The storage box with heating function according to claim 1, characterized in that the number, size, and vertical position of the notches (131) on the pressure plate (11) correspond to the circular holes (111), allowing makeup brushes to pass through the circular holes (111), notches (131), and holes (151) in sequence and enter the interior of the cover (10), where they are secured by the cross-shaped notches (131) formed in the silicone film (13).

4. The storage box with heating function according to claim 1, characterized in that the fan (33) is a centrifugal fan, the upper shell (31) is groove-shaped, and the air outlet (313) is centrally symmetrically designed for bidirectional air outflow.

5. The storage box with heating function according to claim 1, characterized in that the protective shell cover (342) is connected and fixed to the protective shell (341) via buckles, forming a chamber; the fan (33) directs air into the protective shell (341), and the airflow passes over the heating unit (344) before being discharged through the air outlet (3411), creating a flow channel.

6. The storage box with heating function according to claim 1, characterized in that the fan (33) further includes a fan bracket (331), which secures the fan (33) and the heating module (34) that works in conjunction with the fan, to the bottom of the upper shell (31).
